(19) United States
(12) Patent Application Publication
(10) Pub. No.: US 2019/0141047 A1
(43) Pub. Date: May 9, 2019

(54) VEHICLE NETWORK ACCESS CONTROL METHOD AND INFOTAINMENT APPARATUS THEREFOR

(71) Applicant: ELECTRONICS AND TELECOMMUNICATIONS RESEARCH INSTITUTE, Daejeon (KR)

(72) Inventors: Sok Joon LEE, Daejeon (KR); Hyeok Chan KWON, Daejeon (KR); Byung Ho CHUNG, Daejeon (KR); Joong Yong CHOI, Sejong-si (KR)

(73) Assignee: ELECTRONICS AND TELECOMMUNICATIONS RESEARCH INSTITUTE, Daejeon (KR)

(21) Appl. No.: 16/182,596

(22) Filed: Nov. 6, 2018

(30) Foreign Application Priority Data
Nov. 7, 2017 (KR) 10-2017-0147251

(51) Int. Cl. H04L 29/06; H04W 4/40; H04W 12/08

(52) U.S. Cl. CPC H04L 63/102; H04W 12/08; H04L 63/205; H04W 4/40

(57) ABSTRACT

Disclosed is a vehicle network access control method and infotainment apparatus thereof. According to one aspect of the present disclosure, a vehicle network access control method comprises: checking an access subject on the basis of at least one among an ID of the terminal device, an application ID, and a user ID of the infotainment apparatus; determining an access right on the basis of at least one among the access subject, state information of the terminal device, and vehicle state information; and controlling vehicle network access of the infotainment apparatus according to the determined access right, wherein the access right comprises at least one among access permission, access denial, and access permission within a preset time.

### CROSS REFERENCE TO RELATED APPLICATION

The present application claims priority to Korean Patent Application No. 10-2017-0147251, filed Nov. 7, 2017, the entire contents of which is incorporated herein for all purposes by this reference.

### BACKGROUND OF THE INVENTION

### Field of the Invention

The present disclosure relates generally to a vehicle network access control method and an infotainment apparatus therefor. More particularly, the present disclosure relates to a vehicle network access control method and an infotainment apparatus therefor, the method and apparatus being capable of preventing abnormal access by dynamically determining an access right to a vehicle network.

### Description of the Related Art

With development of the Internet and wireless communication technology and emergence of smart phones, users can utilize various types of Internet-based application services such as games, web surfing, news, social services, easy e-mail exchange, and the like, anytime and anywhere over the Internet. In the meantime, as the convergence of a vehicle and Information and Communications Technology (ICT) results in a smart vehicle wherein safety during driving and convenience are enhanced, a number of ICT-based services have been grafted onto the existing vehicles that provided only mobility.

These services generally include a service in which a smart phone accesses an in-vehicle infotainment apparatus mounted on a head unit of the vehicle, and then various types of information that the vehicle is aware of, such as vehicle diagnosis information, traffic information, which includes accident information during driving the vehicle, and the like, are provided via a smart device. Communication performed in the relevant service process is called vehicle-to-nomadic device (V2N) communication or vehicle-to-device (V2D) communication.

V2N communication is advantageous in that the user may directly receive the vehicle-related service from a nomadic device, such as a smart phone of the user. However, by making bad use of V2N communication, when malicious codes are introduced into the vehicle through the infotainment apparatus or hacking is attempted beyond rights of the application in the vehicle, it causes serious problems in terms of privacy and safety of the vehicle.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure has been made keeping in mind the above problems occurring in the related art, and the present disclosure is intended to propose a method of enabling an application of an external terminal device or an application of an infotainment apparatus to access an in-vehicle network, such as a controller area network (CAN) only within normal rights, when the application, which is responsible for V2N communication within the infotainment apparatus of a vehicle, tries to access the network.

Also, the present disclosure is intended to propose a method enabling an application of an external terminal device or an application of an infotainment apparatus to receive only proper packets.

It is to be understood that technical problems to be solved by the present disclosure are not limited to the aforementioned technical problems and other technical problems which are not mentioned will be apparent from the following description to a person with an ordinary skill in the art to which the present disclosure pertains.

According to one aspect of the present disclosure, a vehicle network access control method for an infotainment apparatus connected to a terminal device, the method may comprise checking an access subject on the basis of at least one among an ID of the terminal device, an application ID, and a user ID of the infotainment apparatus, determining an access right on the basis of at least one among the access subject, state information of the terminal device, and vehicle state information, and controlling vehicle network access of the infotainment apparatus according to the determined access right, wherein the access right comprises at least one among access permission, access denial, and access permission within a preset time.

In the vehicle network access control method according to the present invention, wherein the state information of the terminal device comprises at least one among position information, speed information, and access information of the terminal device.

In the vehicle network access control method according to the present invention, wherein the vehicle state information comprises at least one among speed information, position information, engine information, transmission information, brake information, and breakdown information of a vehicle.

In the vehicle network access control method according to the present invention, wherein at the determining of the access right, a distance between the terminal device and a vehicle is calculated on the basis of position information of the terminal device, which is included in the state information of the terminal device, and position information of the vehicle, which is included in the vehicle state information, and the access right is determined as the access permission when the calculated distance is within a preset distance.

In the vehicle network access control method according to the present invention, wherein at the determining of the access right, whether a vehicle is moving is checked on the basis of speed information of the vehicle, which is included in the vehicle state information, and the access right is determined depending on whether the vehicle is moving.

In the vehicle network access control method according to the present invention, wherein at the determining of the access right, the access right is determined as the access denial when the access subject is not a pre-defined access subject.

According to one aspect of the present disclosure, an infotainment apparatus connected to a terminal device, the apparatus may comprise an access subject management module checking an access subject on the basis of at least one among an ID of the terminal device, an application ID, and a user ID of the infotainment apparatus, an access control rule management module determining an access right on the basis of at least one among the access subject, state information of the terminal device, and vehicle state information and an access control module controlling vehicle network access of the infotainment apparatus according to the determined access right, wherein the access right comprises at least one among access permission, access denial, and access permission within a preset time.

In the infotainment apparatus according to the present invention, wherein the state information of the terminal device comprises at least one among position information, speed information, and access information of the terminal device.

In the infotainment apparatus according to the present invention, wherein the vehicle state information comprises at least one among speed information, position information, engine information, transmission information, brake information, and breakdown information of the vehicle.

In the infotainment apparatus according to the present invention, wherein the access control rule management module is configured to calculate a distance between the terminal device and the vehicle on the basis of position information of the terminal device, which is included in the state information of the terminal device, and position information of the vehicle, which is included in the vehicle state information, and determine the access right as the access permission when the calculated distance is within a preset distance.

In the infotainment apparatus according to the present invention, wherein the access control rule management module is configured to check whether the vehicle is moving, on the basis of speed information of the vehicle, which is included in the vehicle state information, and determine the access right depending on whether the vehicle is moving.

In the infotainment apparatus according to the present invention, wherein the access control rule management module determines the access right as the access denial when the access subject is not a pre-defined access subject.

It is to be understood that the foregoing summarized features are exemplary aspects of the following detailed description of the present disclosure without limiting the scope of the present disclosure.

According to the present disclosure, abnormal access may be blocked by checking rights of the application within infotainment apparatus for the vehicle to the vehicle network in real time and dynamically.

Also, according to the present disclosure, the risk of hacking a vehicle may be minimized.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a diagram illustrating a connection relation between a terminal device, an infotainment apparatus, and a vehicle network in a V2N service environment;

FIG. 2 is a diagram illustrating configuration of an infotainment apparatus according to an embodiment of the present disclosure;

FIG. 3 is a diagram illustrating vehicle network access control of an infotainment apparatus according to an embodiment of the present disclosure; and

FIG. 4 is a flowchart illustrating a vehicle network access control method according to an embodiment of the present disclosure.

### DETAILED DESCRIPTION OF THE INVENTION

Hereinbelow, exemplary embodiments of the present disclosure will be described in detail with reference to the accompanying drawings such that the disclosure can be easily embodied by one of ordinary skill in the art to which this disclosure belongs. However, the present disclosure may be embodied in various different forms and should not be limited to the embodiments set forth herein.

In describing embodiments of the present disclosure, it is noted that when the detailed description of known configurations or functions related to the present disclosure may make the gist of the present disclosure unclear, the detailed description of thereof will be omitted. Also, portions that are not related to the present disclosure are omitted in the drawings, and like reference numerals designate like elements.

In the present disclosure, when an element is “coupled to”, “combined with”, or “connected to” another element, it can be directly coupled to the other element or intervening elements may be present therebetween. Also, when a component “comprises” or “includes” an element, unless there is another opposite description thereto, the component does not exclude other elements but may further include the elements.

In the present disclosure, the terms “first”, “second”, and the like are only used to distinguish one element from another element. Unless specifically stated otherwise, the terms do not denote an order or importance. Thus, without departing from the scope of the present disclosure, a first element of an embodiment could be termed a second element of another embodiment. Similarly, a second element of an embodiment could also be termed a first element of another embodiment.

In the present disclosure, elements that are distinguished from each other to clearly describe each feature do not necessarily denote that the elements are separated. That is, a plurality of elements may be integrated into one hardware or software unit, or one element may be distributed into a plurality of hardware or software units. Accordingly, even if not mentioned, the integrated or distributed embodiments are included in the scope of the present disclosure.

In the present disclosure, elements described in various embodiments do not denote essential elements, and some of the elements may be optional. Accordingly, an embodiment that includes a subset of elements described in another embodiment is included in the scope of the present disclosure. Also, an embodiment that includes the elements which are described in the various embodiments and additional other elements is included in the scope of the present disclosure.

Hereinafter, the embodiments of the present disclosure will be described with reference to the accompanying drawings.

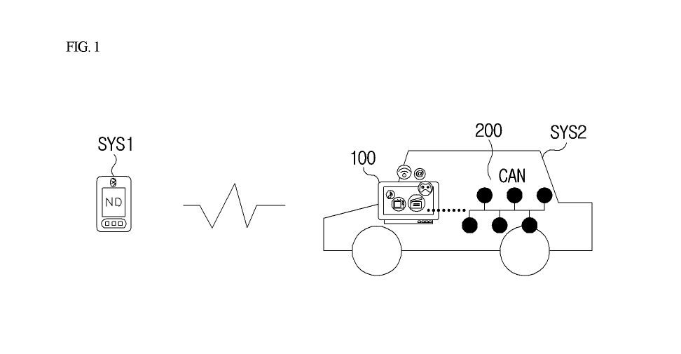

FIG. 1 is a diagram illustrating a connection relation between a terminal device SYS1, an infotainment apparatus 100, and a vehicle network 200 in a V2N (or V2D) service environment.

Referring to FIG. 1, the terminal device SYS1 may be connected to the infotainment apparatus 100 of a vehicle SYS2. The connection may be made by a server of a vehicle company over mobile network, a local area wireless network such as wireless LAN (WiFi) or Bluetooth, or may be directly made by wired connection.

The terminal device SYS1 described in this specification may be called a nomadic device, which may be a mobile phone, a smart phone, a laptop computer, a digital broadcasting terminal, a personal digital assistant (PDA), a portable multimedia player (PMP), or the like. Here, the terminal device SYS1 may execute a vehicle diagnosis function application (or app) and a remote control function app.

The user may make a request for diagnosis information of a current vehicle through an application of the terminal device SYS1. When the request is transmitted to a diagnosis application of the infotainment apparatus 100, the diagnosis application of the infotainment apparatus 100 transmits a packet for requesting vehicle state information to a Controller Area Network (CAN) 200 which is the vehicle network. In this case, an electronic control unit (ECU) of each vehicle component (an engine, a transmission, a brake, a fuel tank, and the like) connected to the vehicle network 200 may generate vehicle state information by detecting state of the vehicle component. Each ECU may transmit the generated vehicle state information to the infotainment apparatus 100 over the vehicle network 200 in a broadcast manner. The infotainment apparatus 100 may analyze and directly display the vehicle state information transmitted over the vehicle network 200, or may transmit the state information to the terminal device SYS1 connected thereto.

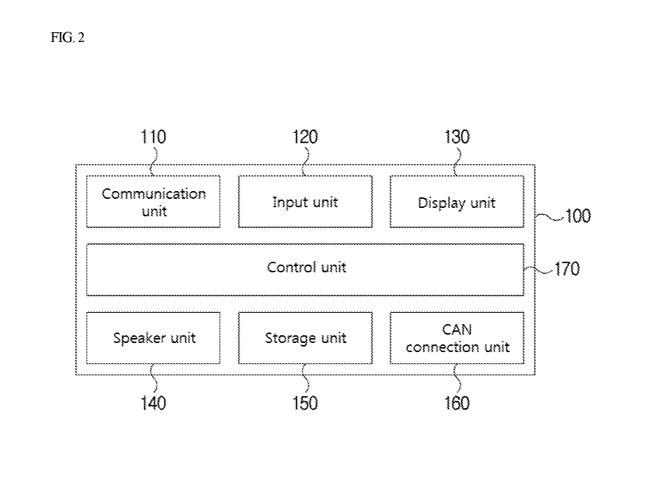

FIG. 2 is a diagram illustrating configuration of an infotainment apparatus 100 according to an embodiment of the present disclosure.

The infotainment apparatus 100 may include a communication unit 110, an input unit 120, a display unit 130, a speaker unit 140, a storage unit 150, and a vehicle network connection unit 160.

The communication unit 110 may provide communication means for transmitting messages or signals between the infotainment apparatus 100 and an external terminal device. The communication unit 110 may include a local area communication module, a mobile communication module, a GPS module, a wired data port, and the like.

The local area communication module may support at least one among WiFi, near-field communication (NFC), Bluetooth, radio-frequency identification (RFID), Infrared Data Association (IrDA), ultra-wideband (UWB), and ZigBee.

The mobile communication module may support at least one mobile communication standard such as Wideband Code Division Multiple Access (WCDMA), High Speed Packet Access (HSPA), Long-Term Evolution (LTE)/LTE Advanced, and the like.

The input unit 120 may provide a means for receiving information from the user. Examples of the input unit 120 may include a touch key, a push key (a mechanical key), and the like.

The display unit 130 may provide a means for outputting an image according to a control signal of a control unit 170. The display unit 130 may have a layer structure with a touch sensor or may be integrally famed therewith, such that a touch screen is realized. The touch screen serves as the input unit 120 providing an input interface between the infotainment apparatus 100 and the user and also providing an output interface between the infotainment apparatus 100 and the user.

The speaker unit 140 may provide a means for outputting sound according to the control signal of the control unit 170.

The storage unit 150 may store applications running on the infotainment apparatus 100 and data and instructions for operation of the infotainment apparatus 100. Here, at least some of the applications may be downloaded from outside via the communication unit 110. In the meantime, the applications may be stored in the storage unit 150 and installed on the infotainment apparatus 100 so as to perform operation or function of the infotainment apparatus by the control unit 170.

The vehicle network connection unit 160 provides a means for connecting the infotainment apparatus 100 to the vehicle network. As described above, the vehicle network is connected to the ECU of each vehicle component, and the vehicle state information detected by the ECU is transmitted to the infotainment apparatus 100 by the vehicle network connection unit 160.

The control unit 170 may control overall input/output and operation of each component within the infotainment apparatus 100. Also, the control unit 170 may provide or process information appropriate for the user by running applications stored in the storage unit 150.

In the meantime, the control unit 170 may perform a function of preventing a malicious application illegally installed on the infotainment apparatus from accessing the vehicle network or preventing an unauthorized terminal device from accessing the vehicle network.

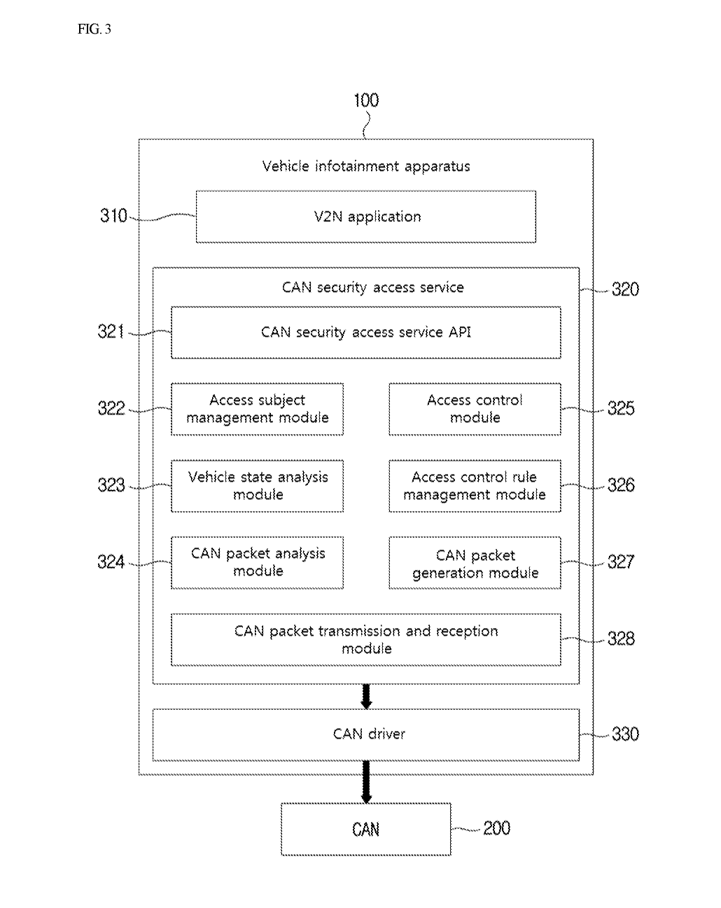

Hereinafter, a vehicle network access control method of the infotainment apparatus 100 will be described with reference to FIG. 3. In the meantime, each application, service, module, and driver shown in FIG. 3 may be run by the control unit 170 shown in FIG. 2.

Referring to FIG. 3, the infotainment apparatus 100 may provide a CAN security access service 320 to prevent abnormal access to the vehicle network in a V2N service environment. Here, the CAN 200 may mean the vehicle network connected to the ECU.

In the meantime, examples of the V2N service or the V2N application may include a vehicle state monitoring application, a vehicle breakdown diagnosis application, a mirroring application of the terminal device, a remote control application, and the like.

The CAN security access service 320 may include a CAN security access service API 321, an access subject management module 322, a vehicle state analysis module 323, a CAN packet analysis module 324, an access control module 325, an access control rule management module 326, a CAN packet generation module 327, and a CAN packet transmission and reception module 328.

Specifically, the CAN security access service application program interface API 321 may be connected to at least one V2N application 310. That is, the V2N application 310 requests access to the CAN via the CAN security access service API 321 instead of directly transmitting an information request packet to a CAN driver 330.

Here, the CAN security access service API 321 may receive, from the V2N application 310, at least one among an application ID, an application user ID, a terminal device access ID, request information, access information of the terminal device, and state information of the terminal device.

The application ID may mean information for identifying the application.

The application user ID may mean information for identifying a user who uses the application.

The terminal device access ID may be information for identifying a terminal device connected to the infotainment apparatus 100.

The request information may be vehicle state information that the V2N application 310 desires to obtain.

The access information of the terminal device may include information on the communication type, MAC address information, and information indicating security communication.

The state information of the terminal device may include position information of the terminal device and speed information of the terminal device.

The access subject management module 322 may store at least one among an authorized application ID, application user ID, and terminal device access ID. Also, the access subject management module 322 may check an access subject by receiving, from the access control module 325, at least one among an application ID, an application user ID, and a terminal device access ID that request vehicle information.

The vehicle state analysis module 323 may generate vehicle state information by analyzing various types of ECU information received from the CAN packet analysis module 324. Here, the vehicle state information may include at least one among speed information of the vehicle, position information of the vehicle, engine information, transmission information, brake information, and breakdown information.

The CAN packet analysis module 324 continuously monitors the CAN packet received from the CAN packet transmission and reception module 328 since the vehicle was started, and transmits various types of ECU information to the vehicle state analysis module.

The access control module 325 may control the API and the modules that make up the CAN security access service overall. Detailed operation of the access control module 325 will be described below.

The access control rule management module 326 may store and manage an access control rule. Here, the access control rule may be a rule of an access right (access permission and access denial) according to an access subject (the application ID, the application user ID, and the terminal device access ID), an access resource (the vehicle state information which may be obtained from the ECU on the CAN), and an access condition (the state information of the terminal device and the vehicle state information).

The CAN packet generation module 327 may generate the CAN packet according to control of the access control module 325.

The CAN packet transmission and reception module 328 may transmit the CAN packet generated by the CAN packet generation module 327 to the CAN driver 330, and conversely, may transit the CAN packet received from the CAN driver 330 to the CAN packet analysis module 324.

Hereinafter, a detailed operation of the access control module 325 will be described.

When the access control module 325 receives the request for the vehicle information from the V2N application via the CAN security access service API 321, the access control module checks the access subject by transmitting at least one among the application ID, the application user ID, and the terminal device access ID, which request the vehicle information, to the access subject management module 322.

Also, the access control module 325 may receive the vehicle state information from the vehicle state analysis module 323.

The access control module 325 may check the access right according to the access control rule by transmitting at least one among the access subject, the state information of the terminal device, and the vehicle state information to the access control rule management module 326.

As an example of the access control rule, the access right is determined as access permission only when a distance between the terminal device and the vehicle calculated on the basis of the position information of the terminal device and the position information of the vehicle is within a preset distance.

As another example of the access control rule, with respect to a request for particular state information of the vehicle state information, only when the vehicle is not moving, the access right is determined as access permission.

As still another example of the access control rule, only for a previously authorized access subject, the access right is determined as access permission.

Here, in addition to access permission and access denial, the access right may include conditional access permission, such as access permission within a preset time, access permission after re-authentication of the terminal device, access permission after checking the user ID by the infotainment apparatus, and the like.

In the meantime, the access control module 325 may transmit the access right invested from the access control rule management module 326 to the V2N application 310 via the API 321. According to the access right, the V2N application 310 may receive the requested vehicle state information via the API 321.

In describing the CAN security access service of the infotainment apparatus 100, the description has been made only for an example in which the V2N application 310 makes a request to the vehicle network for vehicle state information, but without being limited thereto, it may also be applied to an example in which the V2N application 310 transmits a particular command to a particular ECU on the vehicle network.

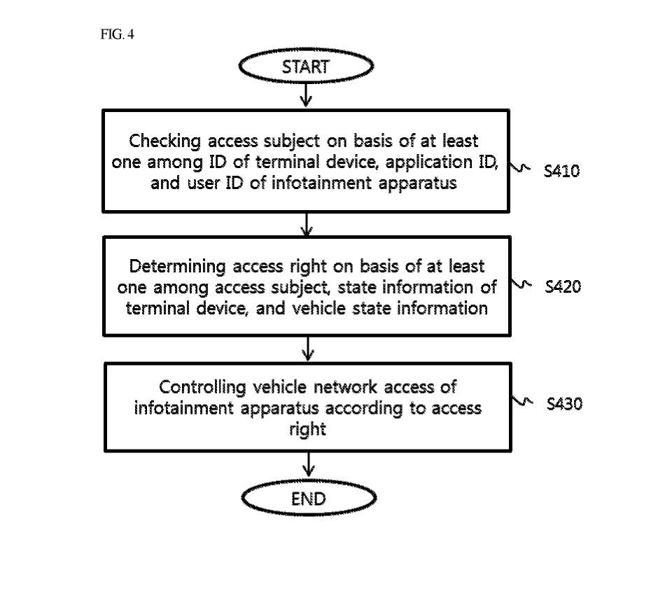

FIG. 4 is a flowchart illustrating a vehicle network access control method according to an embodiment of the present disclosure.

Referring to FIG. 4, the infotainment apparatus may check the access subject on the basis of at least one among an ID of the terminal device connected thereto, the application ID, and the user ID of the infotainment apparatus at step 5410.

Next, the infotainment apparatus may determine the access right at step 5420 on the basis of at least one among the access subject, the state information of the terminal device, and the vehicle state information checked at step 5410.

Here, the state information of the terminal device may include at least one among the position information, the speed information, and the access information of the terminal device.

The vehicle state information may include at least one among the speed information, the position information, the engine information, the transmission information, the brake information, and the breakdown information of the vehicle.

In the meantime, the infotainment apparatus calculates a distance between the terminal device and the vehicle on the basis of the position information of the terminal device, which is included in the state information of the terminal device, and the position information of the vehicle, which is included in the vehicle state information. When the calculated distance is within a preset distance, the access right is determined as access permission.

When the calculated distance is not within the preset distance, the infotainment apparatus determines the access right as access denial.

In the meantime, the infotainment apparatus checks whether the vehicle is moving on the basis of the speed information of the vehicle, which is included in the vehicle state information, and determines the access right depending on whether the vehicle is moving. Specifically, when the vehicle is moving, the infotainment apparatus determines the access right as access denial. Conversely, when the vehicle is not moving, the infotainment apparatus determines the access right as access permission.

Also, when the vehicle is moving, only for particular information (for example, the speed information of the vehicle) of the vehicle state information, the infotainment apparatus determines the access right as access permission.

In the meantime, the infotainment apparatus determines the access right as access denial when the access subject is not a pre-defined access subject.

The infotainment apparatus may control vehicle network access at step 5430 according to the access right determined at step 5420. Here, the access right may include at least one among access permission, access denial, and access permission within a preset time.

In the meantime, according to an embodiment of the present disclosure, in order to perform the vehicle network access control method, software or a computer-readable medium having executable instructions may be provided. The executable instructions may include: an instruction to check the access subject on the basis of at least one among the ID of the terminal device, the application ID, and the user ID of the infotainment apparatus; an instruction to determine the access right on the basis of at least one among the access subject, the state information of the terminal device, and the vehicle state information; and an instruction to control vehicle network access of the infotainment apparatus according to the determined access right.

Although exemplary methods of the present disclosure are represented as a series of operations for clarity of description, the order of the steps is not limited thereto. When necessary, the illustrated steps may be performed simultaneously or in a different order. In order to realize the method according to the present disclosure, other steps may be added to the illustrative steps, some steps may be excluded from the illustrative steps, or some steps may be excluded while additional steps may be included.

The various embodiments of the present disclosure are not intended to list all possible combinations, but to illustrate representative aspects of the present disclosure. The matters described in the various embodiments may be applied independently or in a combination of two or more.

Also, the various embodiments of the present disclosure may be implemented by hardware, firmware, software, or a combination thereof. With hardware implementation, the embodiment may be implemented by using at least one selected from a group of application specific integrated circuits (ASICs), digital signal processors (DSPs), digital signal processing devices (DSPDs), programmable logic devices (PLDs), field programmable gate arrays (FPGAs), general-purpose processors, controllers, micro controllers, micro processors, etc.

The scope of the present disclosure includes software or machine-executable instructions (e.g., an operating system, an application, firmware, a program, etc.) that cause operation according to the methods of the various embodiments to be performed on a device or a computer, and includes a non-transitory computer-readable medium storing such software or instructions which are executable on a device or a computer.

What is claimed is:

1. A vehicle network access control method for an infotainment apparatus connected to a terminal device, the method comprising:
checking an access subject on the basis of at least one among an ID of the terminal device, an application ID, and a user ID of the infotainment apparatus;
determining an access right on the basis of at least one among the access subject, state information of the terminal device, and vehicle state information; and
controlling vehicle network access of the infotainment apparatus according to the determined access right,
wherein the access right comprises at least one among access permission, access denial, and access permission within a preset time.

2. The method of claim 1, wherein the state information of the terminal device comprises at least one among position information, speed information, and access information of the terminal device.

3. The method of claim 1, wherein the vehicle state information comprises at least one among speed information, position information, engine information, transmission information, brake information, and breakdown information of a vehicle.

4. The method of claim 1, wherein at the determining of the access right,
a distance between the terminal device and a vehicle is calculated on the basis of position information of the terminal device, which is included in the state information of the terminal device, and position information of the vehicle, which is included in the vehicle state information, and
the access right is determined as the access permission when the calculated distance is within a preset distance.

5. The method of claim 1, wherein at the determining of the access right,
whether a vehicle is moving is checked on the basis of speed information of the vehicle, which is included in the vehicle state information, and
the access right is determined depending on whether the vehicle is moving.

6. The method of claim 1, wherein at the determining of the access right,
the access right is determined as the access denial when the access subject is not a pre-defined access subject.

7. An infotainment apparatus connected to a terminal device, the apparatus comprising:
an access subject management module checking an access subject on the basis of at least one among an ID of the terminal device, an application ID, and a user ID of the infotainment apparatus;
an access control rule management module determining an access right on the basis of at least one among the access subject, state information of the terminal device, and vehicle state information; and
an access control module controlling vehicle network access of the infotainment apparatus according to the determined access right,
wherein the access right comprises at least one among access permission, access denial, and access permission within a preset time.

8. The apparatus of claim 7, wherein the state information of the terminal device comprises at least one among position information, speed information, and access information of the terminal device.

9. The apparatus of claim 7, wherein the vehicle state information comprises at least one among speed information, position information, engine information, transmission information, brake information, and breakdown information of the vehicle.

10. The apparatus of claim 7, wherein the access control rule management module is configured to
calculate a distance between the terminal device and the vehicle on the basis of position information of the terminal device, which is included in the state information of the terminal device, and position information of the vehicle, which is included in the vehicle state information, and
determine the access right as the access permission when the calculated distance is within a preset distance.

11. The apparatus of claim 7, wherein the access control rule management module is configured to
check whether the vehicle is moving, on the basis of speed information of the vehicle, which is included in the vehicle state information, and
determine the access right depending on whether the vehicle is moving.

12. The apparatus of claim 7, wherein the access control rule management module determines the access right as the access denial when the access subject is not a pre-defined access subject.
